(19) United States
(12) Patent Application Publication
(10) Pub. No.: US 2026/0047720 A1
(43) Pub. Date: Feb. 19, 2026

(54) STOVE

(71) Applicant: PEAX EQUIPMENT CO, LLC, Bozeman, MT (US)

(72) Inventors: JASON BELAIRE, Bozeman, MT (US); JESSE ANDERSON, Steamboat Springs, CO (US); BRICE BISHOP, Bozeman, MT (US)

(73) Assignee: PEAX EQUIPMENT CO, LLC, Bozeman, MT (US)

(21) Appl. No.: 19/304,564

(22) Filed: Aug. 19, 2025

Related U.S. Application Data
(60) Provisional application No. 63/684,697, filed on Aug. 19, 2024.

(51) Int. Cl. A47J 37/07; A47J 37/06

(52) U.S. Cl. CPC A47J 37/0763; A47J 37/0623; A47J 37/0704

(57) ABSTRACT

A stove includes a flexible wall panel, a top panel, a bottom panel, a front panel, and a plurality of leg brackets, wherein the wall panel is configured in a U-shape and installed between the top panel, the bottom panel, and the front panel, and wherein the plurality of leg brackets are coupled to the top panel and the bottom panel to secure the wall panel, the top panel, the bottom panel, and the front panel together.

### CROSS-REFERENCE TO RELATED APPLICATIONS

This application claims the benefit of U.S. Provisional Patent Application No. 63/684,697 entitled “STOVE” and filed on Aug. 19, 2024, for Jason Belaire et al., which is incorporated herein by reference

### FIELD

This invention relates to stoves and more particularly relates to portable, modular stoves that may be assembled without tools or fasteners.

### BACKGROUND

Stoves are devices that may be used to generate heat inside or on top of the device, for local heating or cooking. Stoves can be powered with many fuels, such as electricity, natural gas, gasoline, wood, and coal.

### SUMMARY

An apparatus includes a flexible wall panel, a top panel, a bottom panel, a front panel, and a plurality of leg brackets, wherein the wall panel is configured in a U-shape and installed between the top panel, the bottom panel, and the front panel, and wherein the plurality of leg brackets are coupled to the top panel and the bottom panel to secure the wall panel, the top panel, the bottom panel, and the front panel together.

A system includes a flexible wall panel, a top panel, a bottom panel, a front panel, a door that is hingedly connected to the front panel, a plurality of leg brackets, and a plurality of legs, each of the plurality of legs installed in one of the plurality of leg brackets, wherein the wall panel is configured in a U-shape and installed between the top panel, the bottom panel, and the front panel, and wherein the plurality of leg brackets are coupled to the top panel and the bottom panel to secure the wall panel, the top panel, the bottom panel, and the front panel together.

A stove includes a flexible wall panel, a top panel, a bottom panel, a front panel, a door that is hingedly connected to the front panel and a handle that secures the door to the front panel, a flue connector configured to attach to an opening in the top panel, a plurality of leg brackets, and a plurality of legs, each of the plurality of legs installed in one of the plurality of leg brackets, wherein the wall panel is configured in a U-shape and installed between the top panel, the bottom panel, and the front panel, and wherein the plurality of leg brackets are coupled to the top panel and the bottom panel to secure the wall panel, the top panel, the bottom panel, and the front panel together, and wherein each of the plurality of leg brackets comprises an adjustment bracket comprising a plurality of adjustment points and each of the plurality of legs comprises a protruding member that is configured to be set at one of the plurality of adjustment points to set a height of the stove.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A depicts one embodiment of a stove in accordance with the subject matter described herein;

FIG. 1B depicts an exploded view of the stove in accordance with the subject matter described herein;

FIG. 2A depicts one embodiment of a door for a stove in accordance with the subject matter described herein;

FIG. 2B depicts an exploded view of a latch of a door for a stove in accordance with the subject matter described herein;

FIG. 3A depicts one embodiment of a front panel for a stove in accordance with the subject matter described herein;

FIG. 3B depicts an exploded view of a front panel for a stove in accordance with the subject matter described herein;

FIG. 4A depicts one embodiment of a leg bracket and a leg for a stove in accordance with the subject matter described herein;

FIG. 4B depicts an exploded view of one embodiment of a leg and a leg bracket in accordance with the subject matter described herein;

FIG. 5A depicts one embodiment of a flue connector and a combination spark arrestor/dampener in accordance with the subject matter described herein; and

FIG. 5B depicts an exploded view of a flue connector and a combination spark arrestor/dampener in accordance with the subject matter described herein.

### DETAILED DESCRIPTION

In general, the subject matter herein describes a stove. The stove may be a portable stove, modular stove, or the like that is assembled using multiple different parts, components, or the like. The stove may be assembled without the use of tools and fasteners such as screws, bolts, or the like to allow for easy and quick assembly, e.g., as a backpacking stove and/or camp stove. The material may be rugged, but lightweight to allow for easy carrying and packing.

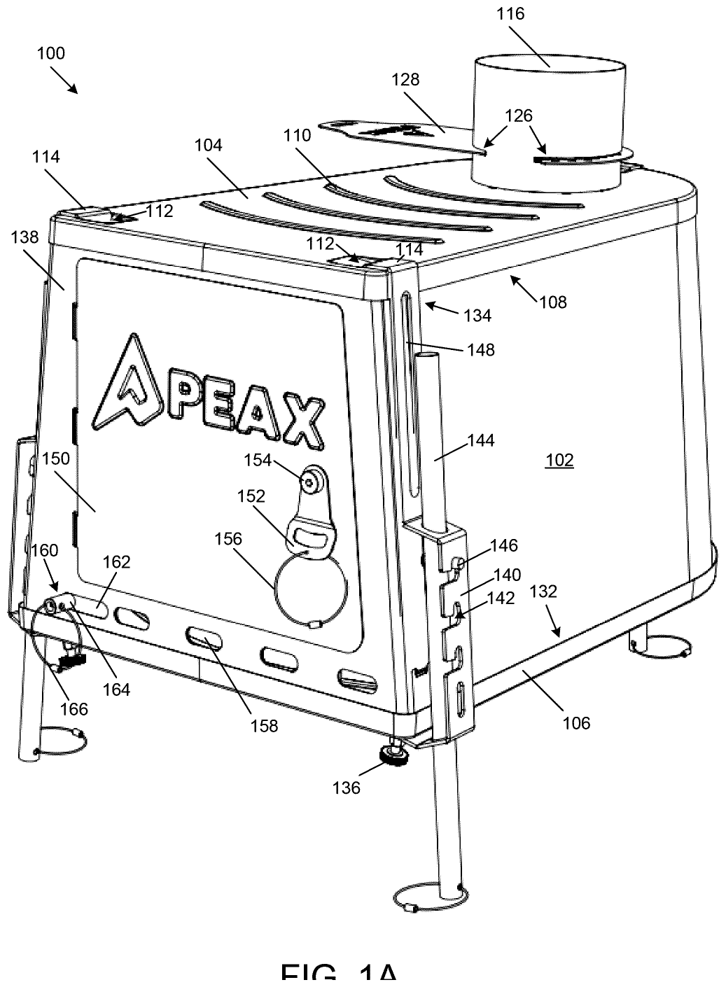

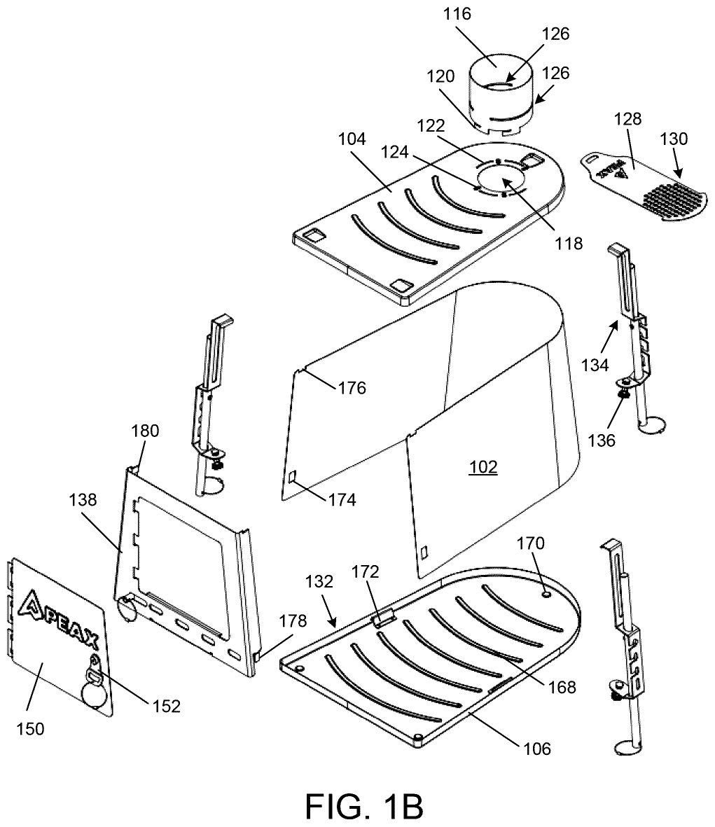

FIG. 1A depicts one embodiment of a stove 100. In one embodiment, the stove 100 includes a wall panel 102. The wall panel 102, in one embodiment, is made of a single piece or sheet of material, e.g., titanium, aluminum, steel, or the like, and is bendable, flexible, or the like to form a curved, U-shaped wall for the stove 100. The U-shaped wall, in certain embodiments, provides a number of advantages as compared with conventional “box”-shaped or style stoves including the use of less material (which is lighter to carry); allows for the use of three legs instead of four or more; creates a vortex within the stove, efficiently moving air in a continuous flow from the front, along the curved portion of the wall panel 102, and out the flue. In such an embodiment, the wall panel 102 is flexed or bent to be placed between a top panel 104 and a bottom panel 106 in the curved or U-shape. In one embodiment, the wall panel 102 can be rolled up to fit inside the flue connector 116 for transport/storage.

In one embodiment, the top panel 104 is configured to secure the wall panel 102 in the curved shape. In one embodiment, the top panel 104 includes a lip 108, edge, or the like that an edge of the wall panel 102 sits in to hold it in a curved shape. In one embodiment, the top panel 104 includes a plurality of ridges 110, crossbars, or lattice reinforcements that act as warp stabilizers to counteract the heat generated within the stove 100 and prevent the top panel 104 from warping, twisting, deforming, or the like from the heat. In certain embodiments, the ridges 110 are embossed in the surface of the top panel 104. In other embodiments, the ridges 110 are engraved into the surface of the top panel 104.

In one embodiment, the top panel 104 includes depressions 112, grooves, slots, or the like (three for a three-legged model, two towards the front and one in the back). The depressions 112 are configured to fit, receive, or the like, an end 114 of a leg bracket 134 that is designed or configured to clip, snap, or otherwise fit into the depressions 112.

In further embodiments, the top panel 104 includes an opening 118, shown in FIG. 1B, for a flue connector 116. The flue connector 116 may be configured to connect a stove pipe, an exhaust pipe, or the like to the stove 100 to exhaust smoke from the stove 100. In such an embodiment, the flue connector 116 includes a plurality of connectors 120 that are configured to be inserted into corresponding slots 122, grooves, openings, or the like in the top panel 104. The flue connector 116 may be secured to the top panel 104 by inserting the connectors 120 into the slots 122 and twisting the flue connector 116 to secure the flue connector 116 to the top panel 104. In such an embodiment, the connectors 120 may be tapered such that they become bigger closer to the point on the body of the flue connector 116 where the connectors 120 are connected to the flue connector 116, making the gap between the connectors 120 and the body of the flue connector 116 smaller or narrower. Accordingly, when the connectors 120 are inserted into the slots 122 and the flue connector 116 is twisted, the flue connector 116 is secured to the top panel 104 by pinching or tightening the top panel 104 material within the gap between the connector 120 and the body of the flue connector 116. In one embodiment, the top panel 104 includes dimples 124 that are stamped or embossed into the top panel 104 and which are configured to slide into the gap between the connectors 122 and the body of the flue connector 116 to tighten the flue connector 116 to the top panel 104.

Furthermore, in one embodiment, the flue connector 116 includes slots 126, gaps, openings, or the like where a dampener and/or spark arrestor 128 can be inserted. As used herein, a spark arrestor may refer to a device that prevents the emission of flammable debris from the stove 100. In one embodiment, the combination dampener/spark arrestor 128 is slidable within the slots 126 to control air flow and prevent sparks from exiting through the flue. In such an embodiment, the dampener/spark arrestor 128 includes a plurality of openings 130 to provide air flow but also prevent sparks from exiting. The openings 130 may be configured or arranged in various patterns, may be different sizes (e.g., 4-5 millimeters), and/or the like.

In one embodiment, a stove pipe may be connected to the flue connector to exhaust smoke from the stove. The stove pipe may comprise a flexible sheet that can be rolled to form a pipe.

Referring again to FIG. 1A, the bottom panel 106 is configured to secure the wall panel 102 in the curved shape. In one embodiment, the bottom panel 106 includes a lip 132, edge, or the like that an edge of the wall panel 102 sits in to hold it in a curved shape. In one embodiment, the bottom panel 104 may include depressions, grooves, slots, dimples, or the like (three for a three-legged model, two towards the front and one in the back). The depressions are configured to fit, receive, or the like, an end of a leg bracket 134 that includes a set screw 136. The set screw 136 may be tightened to secure the leg bracket 134 to the top panel 104 and the bottom panel 106. Tightening the set screw 136 also secures the wall panel 102 between the top panel 104 and the bottom panel 106. Moreover, when the front panel 138 is installed between the top panel 104 and the bottom panel 106, and further secures the wall panel 102 between the top panel 104 and the bottom panel 106, tightening the set screw 136 of the leg bracket 134 holds the stove 100 together (in combination with the other leg brackets 134). In this manner, the stove 100 can be assembled without the use of additional tools or fasteners (e.g., screws, bolts, or the like) and can be quickly disassembled.

In one embodiment, the leg bracket 134 includes an adjustment bracket 140 that includes a plurality of adjustment points 142 for a leg 144 that is inserted into the leg bracket 134. The leg 144 may include a protruding member 146 that is configured to be inserted or slide into an adjustment point 142, which may be configured as a slot with a notch that receives or fits the protruding member 146 of the leg 144. In certain embodiments, the leg bracket 134 includes various cutouts 148 where material is removed to reduce weight but maintain the rigidity and stability of the leg bracket 134.

The front panel 138, in one embodiment, includes a door 150 that is connected to the front panel 138 without the use of fasteners or tools, as explained in more detail below. The door 150 includes a handle 152 that can be turned, rotated, or swiveled about a rotation point 154 to secure or release the front door 150. Also explained in more detail below, the handle 152 includes a corresponding back piece on the back side of the door 150, which, when rotated (e.g., counter-clockwise) to secure the front door 150 to the front panel 138, pinches or clamps the material of the front panel 138 between the handle 152 and the back piece. In one embodiment, the handle 152 includes a ring 156, or other member, that can be used to rotate the handle 152 when the handle 152 is hot.

In one embodiment, the front panel 138 includes one or more vents 158 that are cutout of the front panel 138 to provide air flow into the stove 100. In one embodiment, a dampener 160 that includes a back plate 162 and a handle 164 may be used to slide the dampener 160 along a length of the front panel 138 to open or close one or more vents 158 to control the air flow into the stove 100. In one embodiment, a ring 166, or other member, may be used to move the dampener 160 when the handle 164 is hot.

In one embodiment, the front panel 138 sits inside the lip 108 of the top panel 104 and the lip 132 of the bottom panel 106 and the wall panel 102 sits inside the front panel 138. When the leg brackets 134 are secured/tightened with the set screw 136, the top panel 104, the bottom panel 106, the front panel 138 and the wall panel 102 are secured tightly together.

FIG. 1B depicts an exploded view of the stove 100. In one embodiment, the bottom panel 106 includes a plurality of ridges 168 that act as warp stabilizers to counteract the heat generated within the stove 100 and prevent the bottom panel 106 from warping, twisting, deforming, or the like from the heat. In certain embodiments, the ridges 168 are embossed in the surface of the bottom panel 106. In other embodiments, the ridges 168 are engraved into the surface of the bottom panel 106.

In one embodiment, the bottom panel 106 includes dimples 170 that correspond to the set screw 136 on the leg bracket 134 to help secure the set screw 136 to the bottom panel 106. In one embodiment, the bottom panel 106 includes a resistance member 172, e.g., a tab, that is configured to apply pressure to the wall panel 102 when the wall panel 102 is inserted between the lip 132 and the resistance member 172. The underside of the top panel 104 may also include resistance members 172 for securing the wall panel 102 to the top panel 104. In one embodiment, the wall panel 102 includes holes 174, cutouts, openings, notches 176, or the like that correspond to protrusions 178, clips 180, or the like in the front panel 138 and are configured to secure the wall panel 102 to the front panel 138.

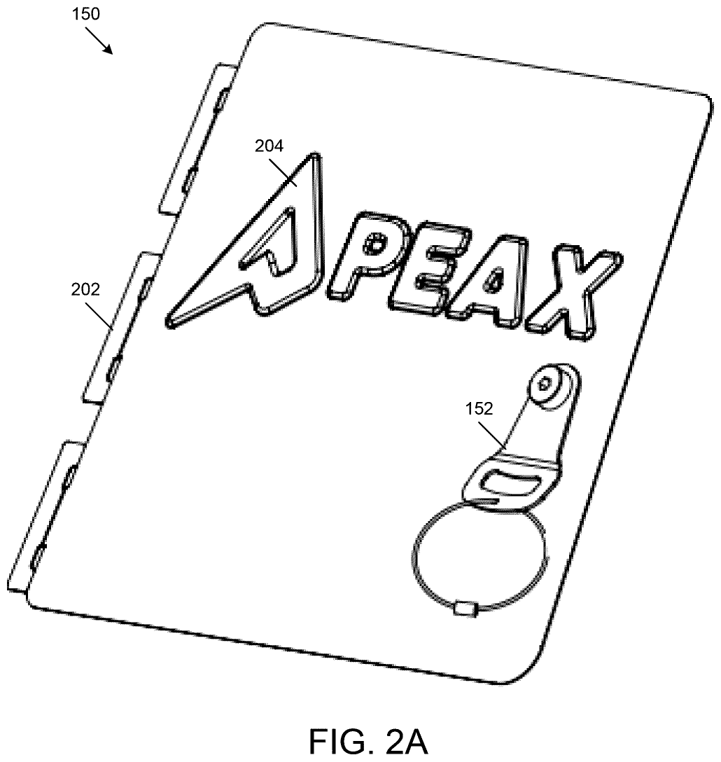

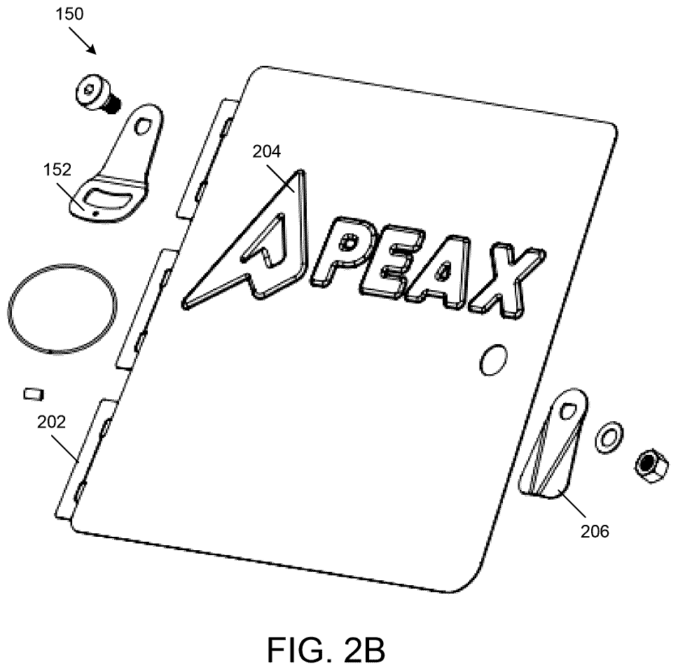

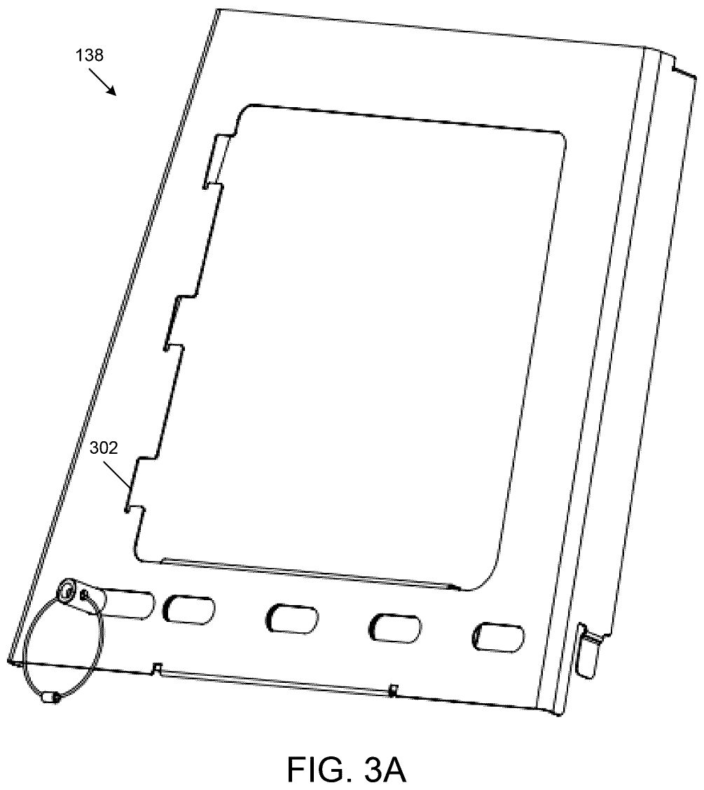

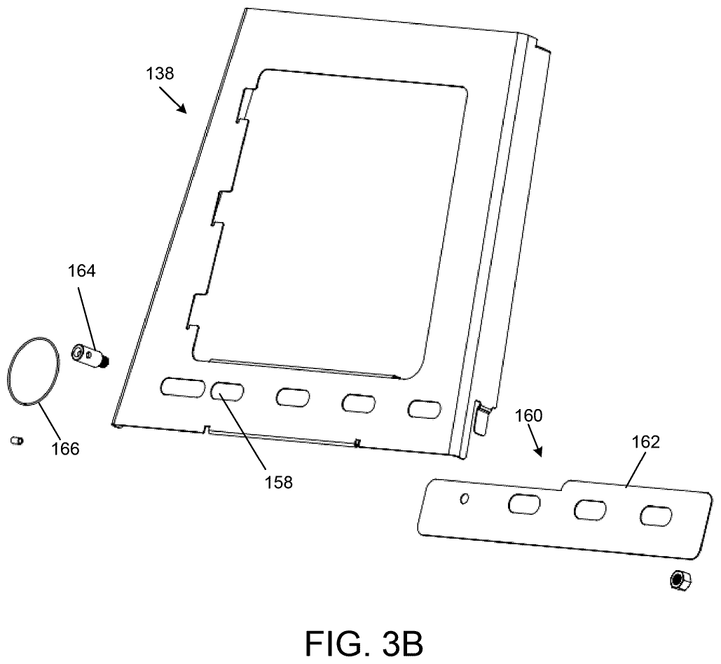

FIG. 2A depicts one embodiment of a door 150. In one embodiment, the door 150 is connected to the front panel by a series of tabs 202 along a side of the door 150 that are connected to corresponding slots in the front panel 138 (as shown in FIG. 3A). In one embodiment, the door 150 may further include ridges 204 (here configured as a company logo) that act as warp stabilizers to counteract the heat generated within the stove 100 and prevent the door 150 from warping, twisting, deforming, or the like from the heat. In certain embodiments, the ridges 204 are embossed in the surface of the door 150. In other embodiments, the ridges 204 are engraved into the surface of the door 150.

FIG. 2B depicts an exploded view of a latch showing the handle 152 and the back piece 206 that acts as a clamp such that when the handle 152 is rotated, the back piece 206 rotates with it and clamps or pinches the front panel 138 to secure the door 150 to the front panel 138.

FIG. 3A depicts one embodiment of a front panel 138. The front panel 138, in one embodiment, includes a plurality of slots 302 that are configured to receive the corresponding tabs 202 on the door 150. In such an embodiment, the tabs 202 may be inserted and pushed into the slots 302 until they are locked in the slots 302 and the door 150 is attached to the front panel 138 without the needs of additional tools or fasteners. The tabs 202 may then act as a hinge such that the door 150 can rotate open and closed.

FIG. 3B depicts an exploded view of a front panel 138. In particular, FIG. 3B shows an exploded view of a dampener 160 that is used to control air flow through the vents 158 in the front panel 138. The handle 164 may be coupled to the back plate 162 and may be used to slide the dampener 160 along a length of the front panel 138 to open or close one or more vents 158 to control the air flow into the stove 100. In one embodiment, a ring 166, or other member, may be used to move the dampener 160 when the handle 164 is hot.

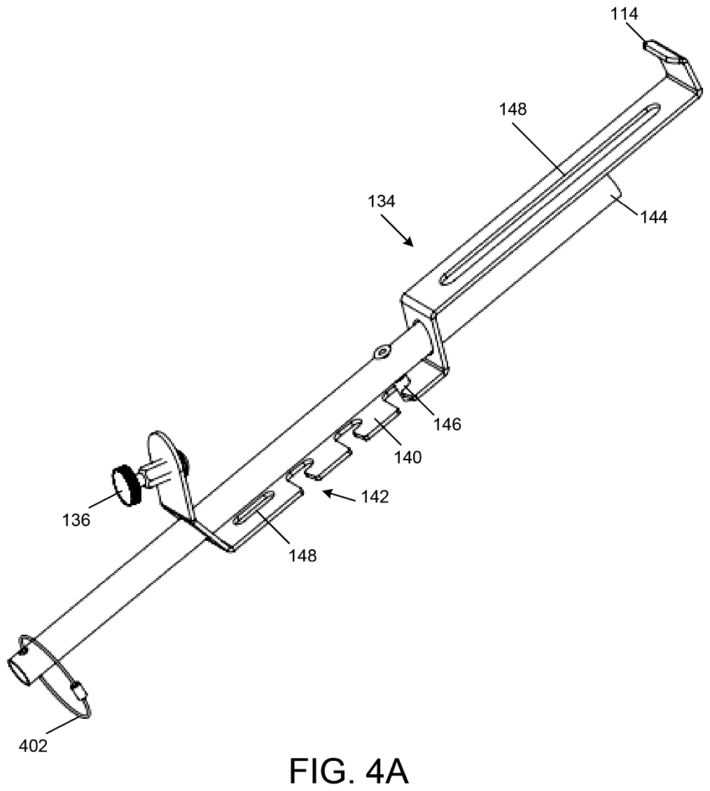

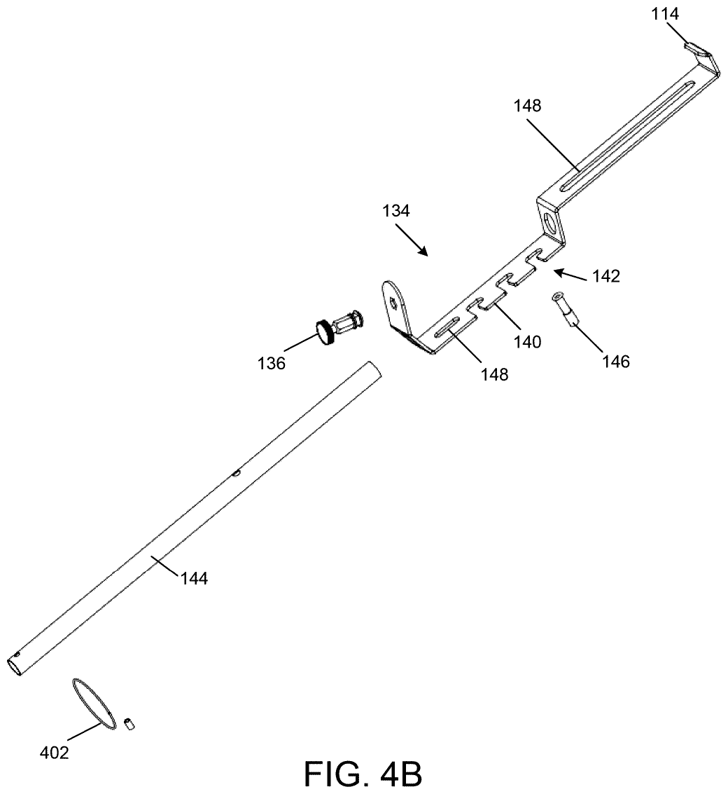

FIG. 4A depicts one embodiment of a leg bracket 134 with a leg 144. In one embodiment, the leg bracket 134 includes an end 114 that is designed or configured to clip, snap, or otherwise fit into a depressions 112 in the top panel 104. Ino ne embodiment, the leg bracket 134 includes a set screw 136 at an opposite end that is configured to secure the leg bracket 134 to the stove 100. The leg bracket 134 further includes an adjustment bracket 140 that includes a plurality of adjustment points 142. The leg 144 may include a protruding member 146 that is configured to be inserted or slid into an adjustment point 142, which may be configured as a slot with a notch that receives or fits the protruding member 146. In certain embodiments, the leg bracket 134 includes various cutouts 148 where material is removed to reduce weight but maintain the rigidity and stability of the leg bracket 134. In one embodiment, the leg 144 includes a ring 402, or other member, that can be used to move or adjust the leg 144 when the stove 100 is hot.

FIG. 4B depicts an exploded view of one embodiment of a leg and a leg bracket.

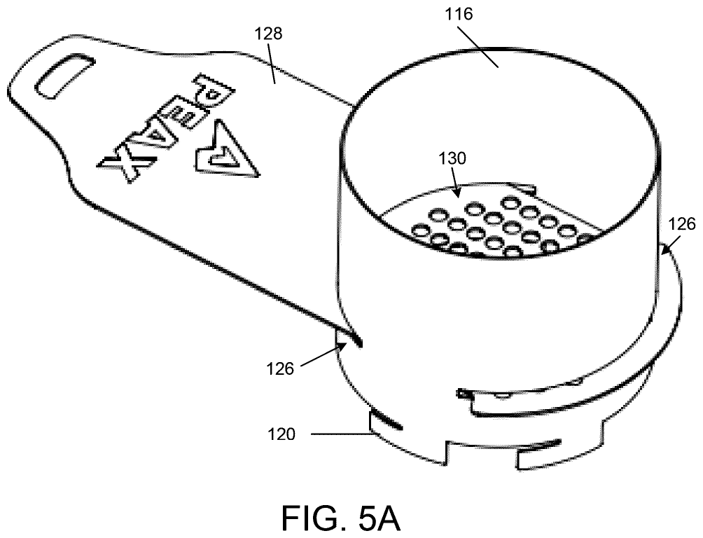

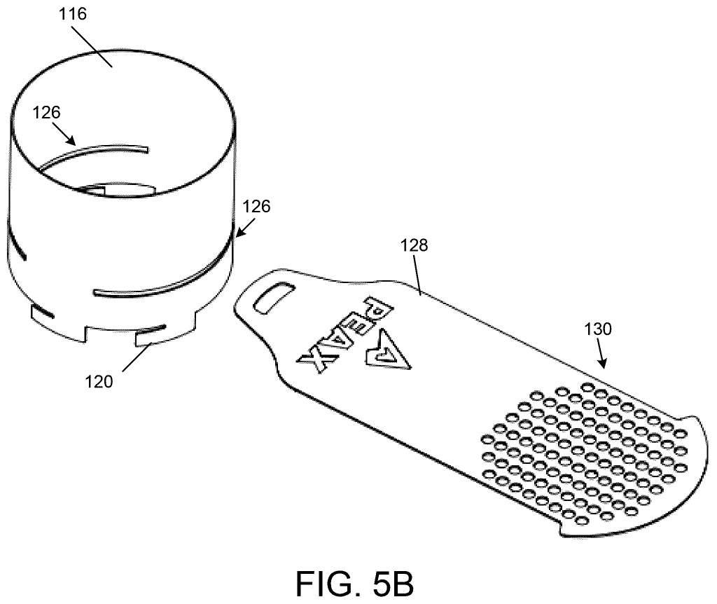

FIG. 5A depicts one embodiment of a flue connector 116 and a combination spark arrestor/dampener 128. In one embodiment, the combination spark arrestor/dampener 128 is inserted into the slots 126 in the flue connector 116. In such an embodiment, the combination spark arrestor/dampener 128 can be adjusted by sliding or moving the combination spark arrestor/dampener 128 to control air flow through the flue connector 116.

As explained above, the flue connector includes a plurality of connectors 120 that are configured to be inserted into corresponding slots 122, grooves, openings, or the like in the top panel 104. The flue connector 116 may be secured to the top panel 104 by inserting the connectors 120 into the slots 122 and twisting the flue connector 116 to secure the flue connector 116 to the top panel 104. In such an embodiment, the connectors 120 may be tapered such that they become bigger closer to the point on the body of the flue connector 116 where the connectors 120 are connected to the flue connector 116, making the gap between the connectors 120 and the body of the flue connector 116 smaller or narrower. Accordingly, when the connectors 120 are inserted into the slots 122 and the flue connector 116 is twisted, the flue connector 116 is secured to the top panel 104 by pinching or tightening the top panel 104 material within the gap between the connector 120 and the body of the flue connector 116. In one embodiment, the top panel 104 includes dimples 124 that are stamped or embossed into the top panel 104 and which are configured to slide into the gap between the connectors 122 and the body of the flue connector 116 to tighten the flue connector 116 to the top panel 104.

FIG. 5B depicts an exploded view of a flue connector and a combination spark arrestor/dampener.

An apparatus includes a flexible wall panel, a top panel, a bottom panel, a front panel, and a plurality of leg brackets, wherein the wall panel is configured in a U-shape and installed between the top panel, the bottom panel, and the front panel, and wherein the plurality of leg brackets are coupled to the top panel and the bottom panel to secure the wall panel, the top panel, the bottom panel, and the front panel together.

In one embodiment, the apparatus includes a plurality of legs, each of the plurality of legs installed in one of the plurality of leg brackets. In one embodiment, each of the plurality of leg brackets comprises an adjustment bracket comprising a plurality of adjustment points and each of the plurality of legs comprises a protruding member that is configured to be set at one of the plurality of adjustment points to set a height of the apparatus.

In one embodiment, each of the plurality of leg brackets comprises a set screw that is configured to secure the plurality of leg brackets to the apparatus. In one embodiment, the top panel comprises a plurality of depressions that a first end of each of the leg brackets connects to and the bottom panel comprises a dimple corresponding to the set screw.

In one embodiment, the apparatus includes a door that is hingedly connected to the front panel. In one embodiment, the door comprises a handle that secures the door to the front panel, the handle rotatable to clamp the door to the front panel.

In one embodiment, the front panel comprises a plurality of vents and a dampener that is movably connected to the front panel to control air flow through the plurality of vents. In one embodiment, the top panel, the bottom panel, or a combination thereof comprises warp stabilization elements. In one embodiment, the warp stabilization elements comprise ridges, crossbars, or lattice reinforcements.

In one embodiment, the apparatus includes a flue connector configured to attach to an opening in the top panel. In one embodiment, the apparatus includes a dampener that is movably connected to the flue connector. In one embodiment, the dampener is slidable within slots of the flue connector. In one embodiment, the dampener comprises openings sized to allow airflow while preventing emission of embers. In one embodiment, the flue connector comprises tapered connectors that twist into slots of the top panel.

In one embodiment, the plurality of leg brackets comprises three leg brackets. In one embodiment, the wall panel is rollable for storage within a flue connector.

A system includes a flexible wall panel, a top panel, a bottom panel, a front panel, a door that is hingedly connected to the front panel, a plurality of leg brackets, and a plurality of legs, each of the plurality of legs installed in one of the plurality of leg brackets, wherein the wall panel is configured in a U-shape and installed between the top panel, the bottom panel, and the front panel, and wherein the plurality of leg brackets are coupled to the top panel and the bottom panel to secure the wall panel, the top panel, the bottom panel, and the front panel together.

A stove includes a flexible wall panel, a top panel, a bottom panel, a front panel, a door that is hingedly connected to the front panel and a handle that secures the door to the front panel, a flue connector configured to attach to an opening in the top panel, a plurality of leg brackets, and a plurality of legs, each of the plurality of legs installed in one of the plurality of leg brackets, wherein the wall panel is configured in a U-shape and installed between the top panel, the bottom panel, and the front panel, and wherein the plurality of leg brackets are coupled to the top panel and the bottom panel to secure the wall panel, the top panel, the bottom panel, and the front panel together, and wherein each of the plurality of leg brackets comprises an adjustment bracket comprising a plurality of adjustment points and each of the plurality of legs comprises a protruding member that is configured to be set at one of the plurality of adjustment points to set a height of the stove.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a flexible wall panel;
a top panel;
a bottom panel;
a front panel; and
a plurality of leg brackets,
wherein the wall panel is configured in a U-shape and installed between the top panel, the bottom panel, and the front panel, and wherein the plurality of leg brackets are coupled to the top panel and the bottom panel to secure the wall panel, the top panel, the bottom panel, and the front panel together.

2. The apparatus of claim 1, further comprising a plurality of legs, each of the plurality of legs installed in one of the plurality of leg brackets.

3. The apparatus of claim 2, wherein each of the plurality of leg brackets comprises an adjustment bracket comprising a plurality of adjustment points and each of the plurality of legs comprises a protruding member that is configured to be set at one of the plurality of adjustment points to set a height of the apparatus.

4. The apparatus of claim 1, wherein each of the plurality of leg brackets comprises a set screw that is configured to secure the plurality of leg brackets to the apparatus.

5. The apparatus of claim 4, wherein the top panel comprises a plurality of depressions that a first end of each of the leg brackets connects to and the bottom panel comprises a dimple corresponding to the set screw.

6. The apparatus of claim 1, further comprising a door that is hingedly connected to the front panel.

7. The apparatus of claim 6, wherein the door comprises a handle that secures the door to the front panel, the handle rotatable to clamp the door to the front panel.

8. The apparatus of claim 6, wherein the door further comprises embossed ridges that act as warp stabilizers.

9. The apparatus of claim 1, wherein the front panel comprises a plurality of vents and a dampener that is movably connected to the front panel to control air flow through the plurality of vents.

10. The apparatus of claim 1, wherein the top panel, the bottom panel, or a combination thereof comprises warp stabilization elements.

11. The apparatus of claim 10, wherein the warp stabilization elements comprise ridges, crossbars, or lattice reinforcements.

12. The apparatus of claim 1, further comprising a flue connector configured to attach to an opening in the top panel.

13. The apparatus of claim 12, further comprising a dampener that is movably connected to the flue connector.

14. The apparatus of claim 13, wherein the dampener is slidable within slots of the flue connector.

15. The apparatus of claim 13, wherein the dampener comprises openings sized to allow airflow while preventing emission of embers.

16. The apparatus of claim 12, wherein the flue connector comprises tapered connectors that twist into slots of the top panel.

17. The apparatus of claim 1, wherein the plurality of leg brackets comprises three leg brackets.

18. The apparatus of claim 1, wherein the wall panel is rollable for storage within a flue connector.

19. A system, comprising:
a flexible wall panel;
a top panel;
a bottom panel;
a front panel;
a door that is hingedly connected to the front panel;
a plurality of leg brackets; and
a plurality of legs, each of the plurality of legs installed in one of the plurality of leg brackets,
wherein the wall panel is configured in a U-shape and installed between the top panel, the bottom panel, and the front panel, and wherein the plurality of leg brackets are coupled to the top panel and the bottom panel to secure the wall panel, the top panel, the bottom panel, and the front panel together.

20. A stove, comprising:
a flexible wall panel;
a top panel;
a bottom panel;
a front panel;
a door that is hingedly connected to the front panel, wherein the door comprises a handle that secures the door to the front panel, the handle rotatable to clamp the door to the front panel;
a flue connector configured to attach to an opening in the top panel;
a plurality of leg brackets; and
a plurality of legs, each of the plurality of legs installed in one of the plurality of leg brackets,
wherein the wall panel is configured in a U-shape and installed between the top panel, the bottom panel, and the front panel, and
wherein the plurality of leg brackets are coupled to the top panel and the bottom panel to secure the wall panel, the top panel, the bottom panel, and the front panel together, and
wherein each of the plurality of leg brackets comprises an adjustment bracket comprising a plurality of adjustment points and each of the plurality of legs comprises a protruding member that is configured to be set at one of the plurality of adjustment points to set a height of the stove.
